(19) United States
(12) Patent Application Publication
(10) Pub. No.: US 2004/0250027 A1
(43) Pub. Date: Dec. 9, 2004

(54) Method and system for comparing multiple bytes of data to stored string segments

(76) Inventor: Kenneth A. Heflinger, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/455,118

(22) Filed: Jun. 4, 2003

(51) Int. Cl. G06F 12/00

(52) U.S. Cl. 711/156; 711/108

(57) ABSTRACT

A method and system for comparing multiple bytes of data to stored string segments is described. The method includes storing a plurality of string segments of one or more target strings in a memory, scanning multiple bytes of data, and comparing in parallel the multiple bytes of scanned data to the stored string segments to determine whether there is a potential match to one of the target strings. After a potential match is found, one or more of the target strings may be compared to the scanned data to determine whether there is an actual match.

### BACKGROUND

1. Technical Field

Embodiments of the invention relate to the field of string searching, and more specifically to comparing multiple bytes of data to stored string segments.

2. Background Information and Description of Related Art

Some network acceleration and load balancing techniques require searching the data in the packets for one or more string constants. This usually requires examining each byte in the packet one at a time until the desired sequence is found. If a search is done for more than one string constant at a time, each byte in the packet may be tested more than once, thus making the search process even slower.

### BRIEF DESCRIPTION OF DRAWINGS

The invention may best be understood by referring to the following description and accompanying drawings that are used to illustrate embodiments of the invention. In the drawings:

FIG. 1 is a block diagram illustrating one generalized embodiment of a system incorporating the invention.

FIG. 2 is a flow diagram illustrating a method according to an embodiment of the invention.

FIG. 3 is a table illustrating exemplary entries in a memory according to one embodiment of the invention.

FIG. 4 is a block diagram illustrating a suitable computing environment in which certain aspects of the illustrated invention may be practiced.

### DETAILED DESCRIPTION

Embodiments of a system and method for comparing multiple bytes of data to stored string segments are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

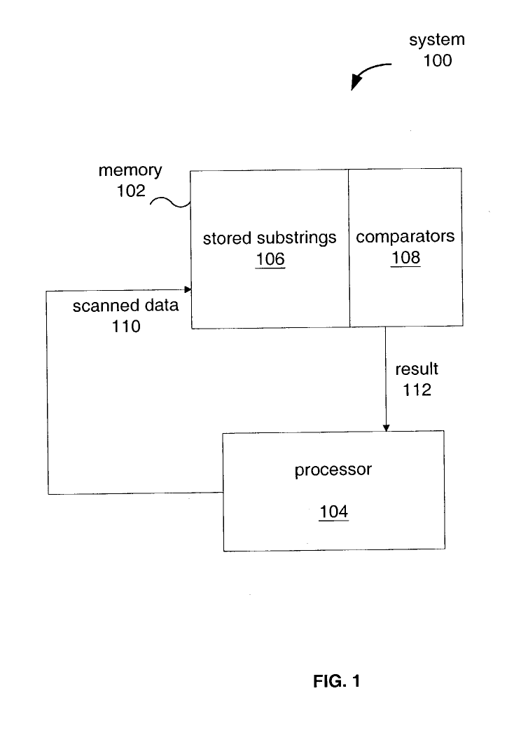

Referring to FIG. 1, a block diagram illustrates a system 100 according to one embodiment of the invention. Those of ordinary skill in the art will appreciate that the system 100 may include more components than those shown in FIG. 1. However, it is not necessary that all of these generally conventional components be shown in order to disclose an illustrative embodiment for practicing the invention.

System 100 includes a processor 104 to process data and a memory 102. The memory 102 stores a plurality of string segments 106 of one or more target strings to be searched for. The memory 102 also includes comparators 108 to compare the stored string segments to data in parallel. In one embodiment, the memory 102 is a Content Addressable Memory (CAM). The processor 104 scans multiple bytes of data. The number of bytes of data scanned at one time is variable and may be predetermined. The scanned data 110 is compared to the stored string segments 106 in parallel via the memory 102 to determine whether there is a potential match to one of the target strings. The result 112 of this comparison is provided to the processor 104. If the result indicates that there is no potential match to one of the target strings, then the processor scans more data. If there is a potential match found, then the processor examines the data to determine whether there is an actual match. In one embodiment, the memory provides an indication to the processor as to which of the target strings the data potentially matches. The processor then compares the potentially matching target string to the data to determine if there is an actual match.

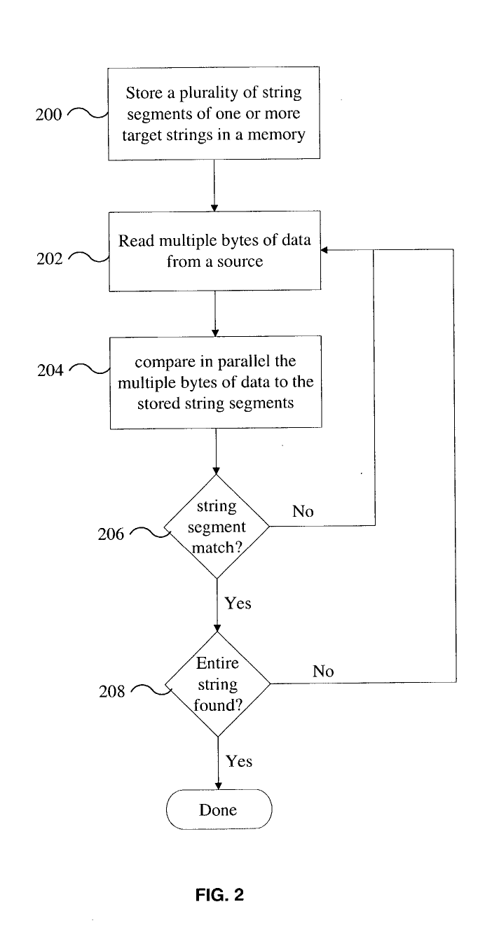

FIG. 2 illustrates a method according to one embodiment of the invention. At 200, a plurality of string segments of one or more target strings is stored in a memory. In one embodiment, the memory is a CAM. In one embodiment, the string segment is the entire target string. In one embodiment, one or more wildcard bytes are stored along with a string segment in the memory. The wildcard bytes will match any byte of data. At 202, multiple bytes of data are read from a source. In one embodiment, the number of bytes of source data exceed the number of bytes of the one or more of the stored string segments. At 204, the multiple bytes of data are compared in parallel to the stored string segments. At 206, a determination is made as to whether there is a potential match to one of the target strings based on the result of the comparison. If there is no potential match, then the process repeats from 202 and more data is read from the source. If there is a potential match, then at 208, the data is examined to determine if there is an actual match to one of the target strings. In one embodiment, the area around the location where the potential match was found is examined to determine if there is an actual match. In one embodiment, a Finite State Automata (FSA) is used to examine the data to determine whether there is an actual match to one of the target strings. If there is no actual match, then the process repeats from 202 and more data is read from the source. If there is an actual match, then the process may be completed.

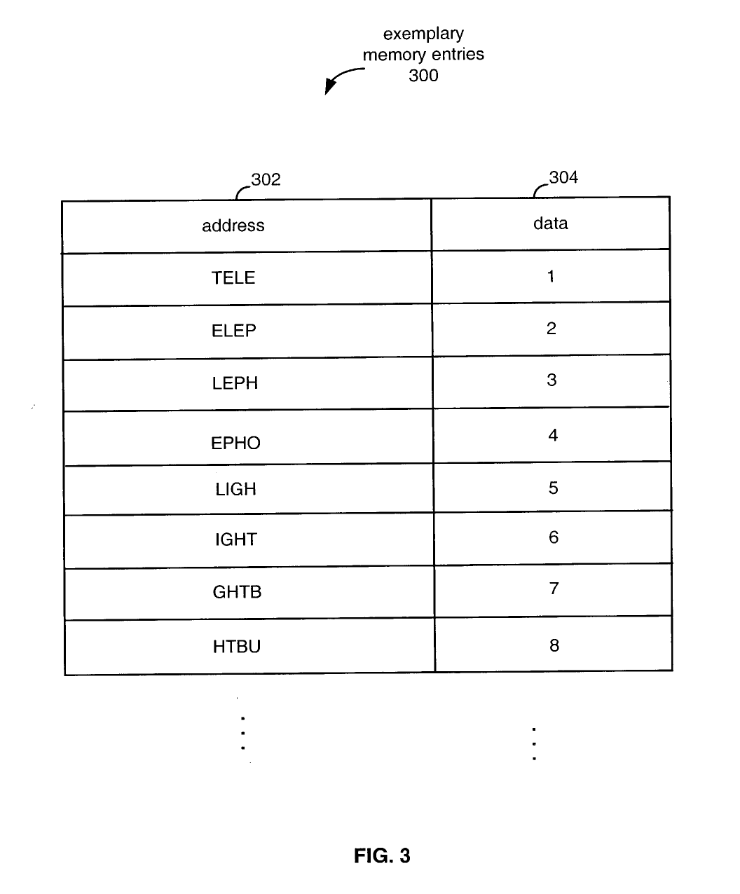

An example will now be discussed for purposes of illustration. Assume that the target strings to be searched for are “telephone” and “lightbulb”. Segments of these two target strings are stored in memory 102, as shown in FIG. 3. Assume that the source data in which the target strings will be searched for contains the following data: “wheel=no, telephone=yes.” Assume that the processor scans four bytes of source data at a time. The first four bytes of source data scanned would be “whee.” These four bytes of data are compared in parallel to the stored string segments in memory 102. There is no match, so the next four bytes of data are scanned. These four bytes, “l=no”, are compared in parallel to the stored string segments. There is no match, so the next four bytes of data are scanned. These four bytes, “.tel”, are compared in parallel to the stored string segments. There is no match, so the next four bytes of data are scanned. These four bytes, “epho”, are compared in parallel to the stored string segments. There is a match to the fourth entry in memory 102. The source data around the string segment match is checked to determine if there is a match to one of the target strings. There is a match to the target string “telephone.” Therefore, the process is complete.

In one embodiment, the comparison that is done in parallel does not have to compare the same number of bits for each entry in the memory. Some entries in the memory may have more or less data in them used for comparison. For example, suppose that the processor scans four bytes of source data at a time, and the target string to be searched for is “CAT.” The stored string segments or strings in memory may be follows: “AT??” in entry 0, “CAT?” in entry 1, “?CAT” in entry 2, and “??CA” in entry 3. The “?” is a wildcard that represents “any byte”, which means it does not have to match any particular source data. If the scanned source data matches entry 1 or entry 2, then the target string “CAT” has been found, and no further verification is needed. If the scanned source data matches entry 0 or entry 3, then only a string segment of the target string has been found. Therefore, the source data needs to be checked to determine if there is an actual match to the target string.

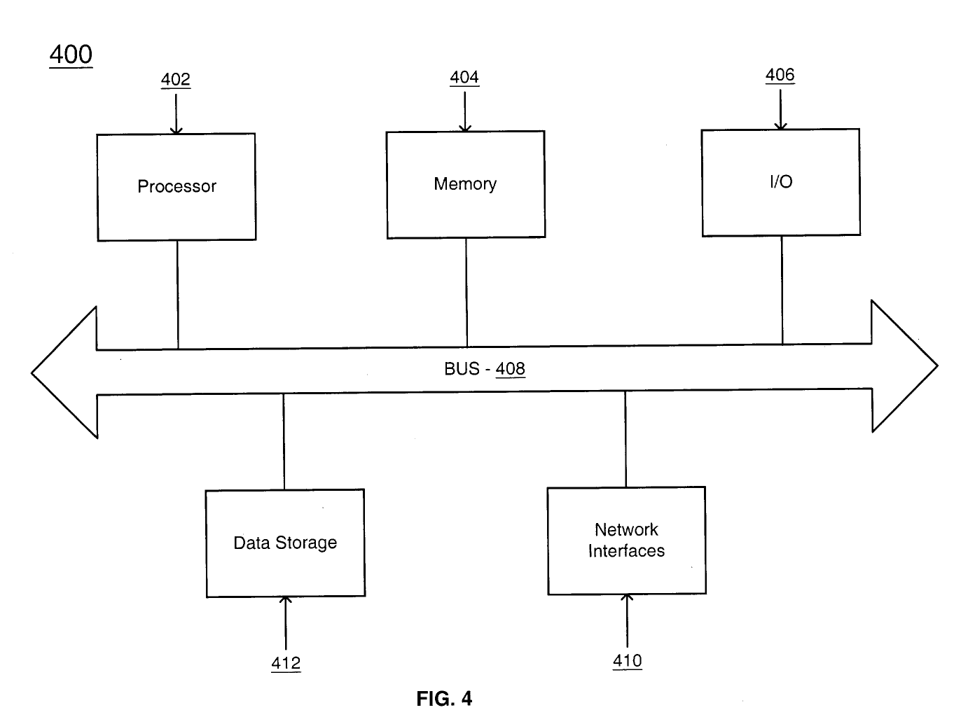

FIG. 4 is a block diagram illustrating a suitable computing environment in which certain aspects of the illustrated invention may be practiced. In one embodiment, the method described above may be implemented on a computer system 400 having components 402-412, including a processor 402, a memory 404, an Input/Output device 406, a data storage 412, and a network interface 410, coupled to each other via a bus 408. The components perform their conventional functions known in the art and provide the means for implementing the system 100. Collectively, these components represent a broad category of hardware systems, including but not limited to general purpose computer systems and specialized packet forwarding devices. It is to be appreciated that various components of computer system 400 may be rearranged, and that certain implementations of the present invention may not require nor include all of the above components. Furthermore, additional components may be included in system 400, such as additional processors (e.g., a digital signal processor), storage devices, memories, and network or communication interfaces.

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
storing a plurality of string segments of one or more target strings in a memory;
reading multiple bytes of data; and
comparing in parallel the multiple bytes of data to the stored string segments to determine whether there is a potential match to one of the target strings.

2. The method of claim 1, further comprising comparing one or more of the target strings to the data to determine whether there is an actual match if it is determined that there is a potential match.

3. The method of claim 2, wherein comparing one or more of the target strings to the data to determine whether there is an actual match comprises examining the data proximate to the location where the potential match was found to determine whether there is an actual match to one of the target strings.

4. The method of claim 2, wherein comparing one or more of the target strings to the data to determine whether there is an actual match comprises utilizing a Finite State Automata (FSA) to examine the data to determine whether there is an actual match to one of the target strings.

5. The method of claim 1, wherein comparing in parallel the multiple bytes of data to the stored string segments comprises comparing in parallel via the memory the multiple bytes of data to the stored string segments to determine whether there is a potential match to one of the target strings.

6. The method of claim 1, wherein storing a plurality of string segments of one or more target strings in a memory comprises storing a plurality of string segments of one or more target strings in a Content Addressable Memory (CAM).

7. The method of claim 1, further comprising reporting the results of the parallel comparison to a processor coupled to the memory.

8. The method of claim 7, further comprising indicating to the processor which of the target strings the data potentially matches.

9. The method of claim 1, wherein the multiple bytes of data read exceed the number of bytes of one or more of the stored string segments.

10. The method of claim 9, wherein storing a plurality of string segments of one or more target strings in a memory comprises storing one or more wildcard bytes that match any byte of data.

11. The method of claim 10, wherein storing a plurality of string segments of one or more target strings in a memory comprises storing the target string and one or more string segments of the target string in the memory.

12. The method of claim 11, wherein comparing in parallel the multiple bytes of data to the stored string segments comprises comparing in parallel the multiple bytes of data to the stored string segments to determine whether there is a potential or actual match to one of the target strings.

13. An apparatus comprising:
a memory to store a plurality of string segments of one or more target strings and to compare in parallel the stored string segments with multiple bytes of scanned data; and
a processor coupled to the memory to process the scanned data and to determine whether there is an actual match to one of the target strings if at least one of the string segments is found in the scanned data.

14. The apparatus of claim 13, wherein the memory is a Content Addressable Memory (CAM).

15. The apparatus of claim 13, wherein the memory includes logic to report the results of the parallel comparison to the processor.

16. The apparatus of claim 13, wherein the memory includes logic to indicate which of the target strings the scanned data potentially matches if at least one of string segments matches the multiple bytes of scanned data.

17. An article of manufacture comprising:
a machine accessible medium including content that when accessed by a machine causes the machine to:
store a plurality of string segments of one or more target strings in a memory;
scan multiple bytes of data;
cause the memory to perform a parallel comparison of the multiple bytes of data to the stored string segments; and
receive a result from the memory indicating whether the parallel comparison resulted in at least one match.

18. The article of manufacture of claim 17, wherein the machine-accessible medium further includes content that causes the machine to compare one or more of the target strings to the scanned data to determine whether there is a match if the result received from the memory indicates that the parallel comparison resulted in at least one match.

19. The article of manufacture of claim 18, wherein the machine accessible medium including content that when accessed by the machine causes the machine to compare one or more of the target strings to the scanned data to determine whether there is a match comprises machine accessible medium including content that when accessed by the machine causes the machine to examine the data proximate to where the match to one of the stored string segments was found to determine if there is a match to one of the target strings.

20. The article of manufacture of claim 17, wherein the machine-accessible medium further includes content that causes the machine to receive an indication from the memory as to which target string potentially matches the scanned data if the parallel comparison resulted in at least one match.

21. The article of manufacture of claim 20, wherein the machine-accessible medium further includes content that causes the machine to compare the potentially matching target string to the scanned data to determine if there is an actual match.

22. The article of manufacture of claim 17, wherein the machine accessible medium including content that when accessed by the machine causes the machine to store a plurality of string segments of one or more target strings in a memory comprises machine accessible medium including content that when accessed by the machine causes the machine to store a plurality of string segments of one or more target strings in a Content Addressable Memory (CAM).

23. A system comprising:
a Dynamic Random Access Memory (DRAM) to store source data;
a Content Addressable Memory (CAM) coupled to the DRAM to store a plurality of string segments of one or more target strings and to compare the stored string segments with multiple bytes of the source data; and
a processor coupled to the DRAM and the CAM to process the source data and to determine whether there is an actual match to one of the target strings if at least one of the stored string segments matches the source data.

24. The system of claim 23, wherein the CAM to further indicate which of the target strings the source data potentially matches if at least one of string segments matches the source data.

25. The system of claim 24, wherein the processor to compare the potentially matching target string to the source data to determine whether there is an actual match.
